(19) United States
(12) Patent Application Publication
(10) Pub. No.: US 2009/0127113 A1
(43) Pub. Date: May 21, 2009

(54) Microfluidic detector and manufacturing method

(76) Inventors: Chien-Hsing Chen, Chia-Yi (TW); Jhih-Lin Chen, Chia-Yi (TW); Wen-Hsin Hsien, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,236

(22) Filed: Nov. 15, 2007

(51) Int. Cl. G01N 27/30; B05D 5/12

(52) U.S. Cl. 204/403.01; 204/409; 427/58

(57) ABSTRACT

A micro-fluidic detector applied for detecting analytes in a fluid sample is disclosed. The micro-fluidic detector comprises a mixing area, a flow area and at least one detection module. The mixing area has a conductive top plate and a plurality of first electrodes for mixing a first fluid and a second fluid so as to form the fluid sample. The flow area has two second electrodes, positioned side by side, for driving the fluid sample to flow. The detection module is used for detecting analytes in the fluid sample flowing in the flow area. The mixing area uniformly mixes the first fluid and the second fluid via an electric field generated by applying a voltage potential, with respect to the conductive top plate, to one by one of the first electrodes in the mixing area. The flow area drives the fluid sample via an electric field generated by the second electrodes.

### BACKGROUND OF THE INVENTION

(a) Field of the Invention

The present invention is related to a micro-fluidic detector and manufacturing method, and more particularly to achieve the purpose of detecting analytes in a fluid sample by applying an electric field to drive the fluid sample.

(b) Description of the Prior Art

Many devices in macro size have been microminiaturized due to the advancement made in MEMS (Micro Electro Mechanical Systems) in recent years. In micro electromechanical research fields, the applications of micro-fluidic devices in bio-medical detection have attracted much attention. The micro-fluidic bio-medical detection chips produced by MEMS processes not only have advantages of high efficacy of detection, low sample consumption, low energy consumption, compact size, low production cost, but also allows the development of disposable chips for minimizing risk of cross contamination. These chips can also be integrated into Micro Total Analysis Systems (μ-TAS) with capabilities of real-time detection and multiplexed analysis. The μ-TAS can bring a major revolution to human life, perform bed-side detection to analyze a personal physiology conditions at any time and any place, and be used for environment detection, food detection and any type of chemical analysis. The μ-TAS is environment-friendly because it is capable of identifying an analyte prepared only in a small amount.

In the past, a micro-fluidic cytometer biochip was developed. FIG. 1 illustrates a top view of a micro-fluidic cytometer biochip of the prior art. Taking virus detection for example, the micro-fluidic cytometer biochip 10 is used for detecting a virus in a fluid sample. The fluid sample contains a fluorescent dye-labelled antibody 12, a virus 13 conjugated with the fluorescent dye-labelled antibody 12, and other substances. A pressure force in a direction 14 is applied to the fluid sample to make the fluid sample flow in the direction 14, and another pressure force from both sides is applied to another fluid to make the fluid flow in a direction 15 as the sheath flow. The laminar flow of the fluid sample permits only one single virus 13 conjugated with the fluorescent dye-labelled antibody at a time to pass the detection window. By adjusting the pressure forces applied to the sheath flow or the fluid sample, the micro-fluidic cytometer biochip 10 can control the number of passed virus 13 and accurately detect the virus 13 conjugated with the fluorescent dye-labeled antibody by detecting the fluorescent light emitted from the virus 13, which is excited by the excitation light 11. The virus 13 conjugated with the fluorescent dye-labeled antibody is then collected by adjusting the pressure applied to the sheath flow from both sides for deflecting the laminar flow of the fluid sample.

FIG. 2 illustrates a cross-sectional view of the micro-fluidic cytometer biochip of the prior art. Because micro-fluidic cytometer biochip 10 pressure-drives the sheath flow and the fluid sample to flow within a space limited by a channel 22 and a lid 23, the pressure may cause the fluid to permeate into a gap 21 between the channel 22 and the lid, and the pressure fluctuation may affect the stability of the laminar flow and result in detection error.

Furthermore, the channel is usually manufactured by an etching process for high quality. FIG. 3 illustrates a schematic view of a manufacturing process of a closed channel of the micro-fluidic cytometer biochip of the prior art. As illustrated, a vitreous substrate 71 is provided at first, and the vitreous substrate 71 is then spin-coated with a photo-resist 72. After exposure and development with a mask, a desired pattern is formed on the photo-resist 72. Sequentially, a channel 22 is formed on the vitreous substrate 71 by using a chemical etching process. After the channel is formed, the photo-resist 71 is then removed and a lid 23 is provided to seal the vitreous substrate 71. If the finished product of the substrate 71 is further processed with additional micro electromechanical manufacturing processes to provide other functions on the substrate 71, the additional micro electromechanical manufacturing processes may damage the quality of the fabricated channel. This indicates the difficulty in the integration of the above-mentioned channel fabrication process with other micro electromechanical manufacturing process. This integration difficulty may very well hinder the development of multi-functional, miniaturized, and portable detectors. Besides, the micro-fluidic cytometer biochip of the prior art consumes too much fluid sample for detection. While pressurizing the fluid to flow, the micro-fluidic cytometer biochip can vibrate. The vibration may affect the detection result of the biochip.

How to solve the drawbacks of the prior art is an important key. The inventor of the present invention develops a micro-fluidic detector and manufacturing method, based on years of experience in the related industry, to overcome the drawbacks of the prior art.

### SUMMARY OF THE INVENTION

Therefore, it is one of the objectives of the present invention to provide a micro-fluidic detector and manufacturing method thereof to detect analytes in a fluid sample by applying an electric field to drive the fluid sample.

To achieve the purpose, the present invention provides a micro-fluidic detector for detecting analytes in a fluid sample. The micro-fluidic detector comprises multiple electrodes and at least one detection module. The electrodes are arranged on the same plane. Two of the electrodes are long and narrow strips positioned side by side and serve as a flow area for the fluid sample. The fluid sample is driven to flow by an electric field generated by the electrodes. The detection module is used for detecting analytes in the fluid sample.

Besides, the present invention further provides a micro-fluidic detector applied for detecting analytes in a fluid sample. The micro-fluidic detector comprises a mixing area, a flow area and at least one detection module. The mixing area has a conductive top plate and multiple first electrodes. A first fluid and a second fluid are mixed, at where between the conductive top plate and the first electrodes, to form the fluid sample. The flow area provides a space for the fluid sample to flow and has at least two second electrodes which are positioned side by side. The detection module is used for detecting analytes in the fluid sample flowing in the flow area. A voltage potential, with respect to the conductive top plate, is applied to one by one of the first electrodes to generate electric field in the mixing area for achieving the mixing of the first fluid and the second fluid. The fluid sample is then driven to flow in the flow area by the electric field generated by the second electrodes.

Accordingly, a micro-fluidic detector based pm the present invention drives a fluid sample by an electric field to create micro-fluidics, so as to achieve the purpose of detecting analytes in the fluid sample.

### BRIEF DESCRIPTION OF THE DRAWINGS

FIG. 1 illustrates a top view of a micro-fluidic cytometer biochip of the prior art.

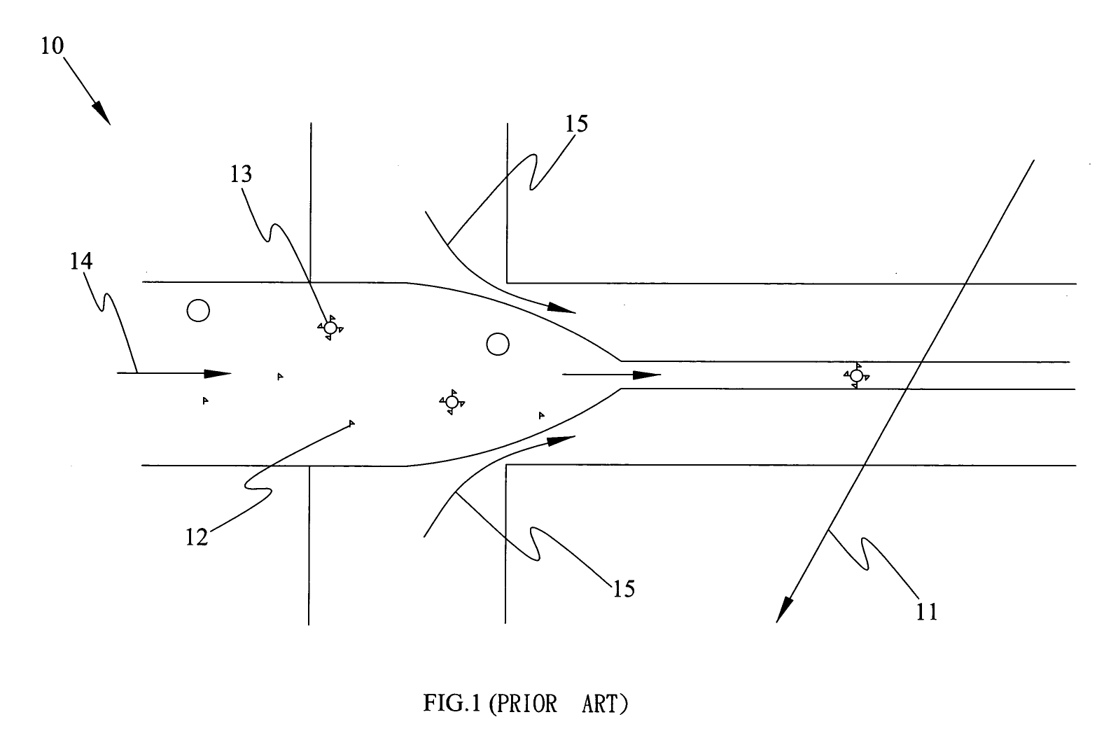

FIG. 2 illustrates a cross-sectional view of the micro-fluidic cytometer biochip of the prior art.

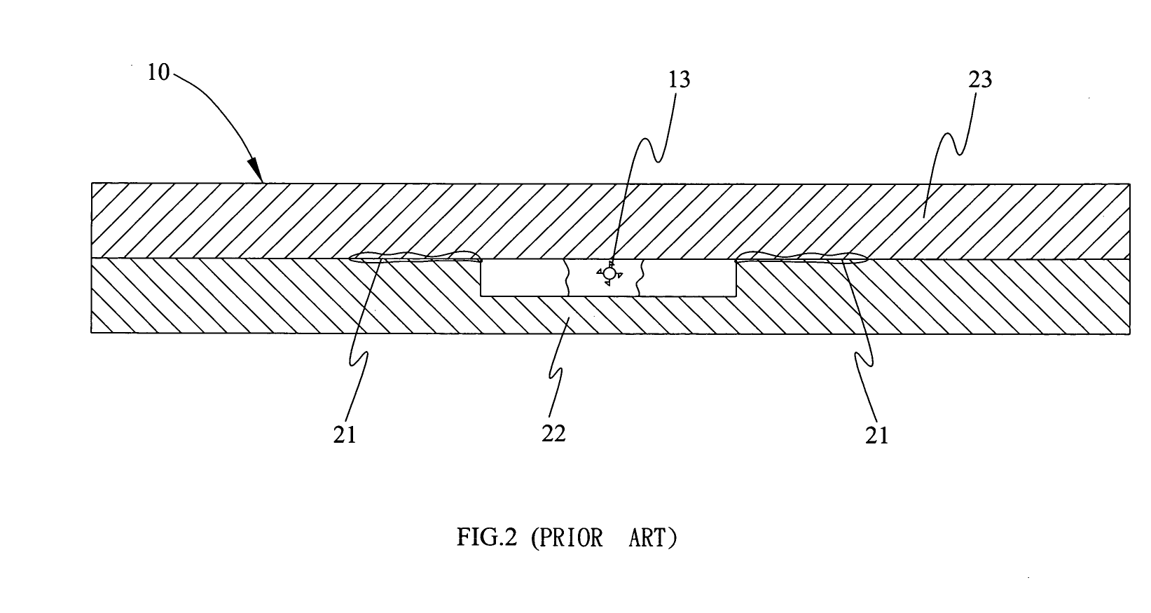

FIG. 3 illustrates a schematic view of a manufacturing process of a closed channel of the micro-fluidic cytometer biochip of the prior art.

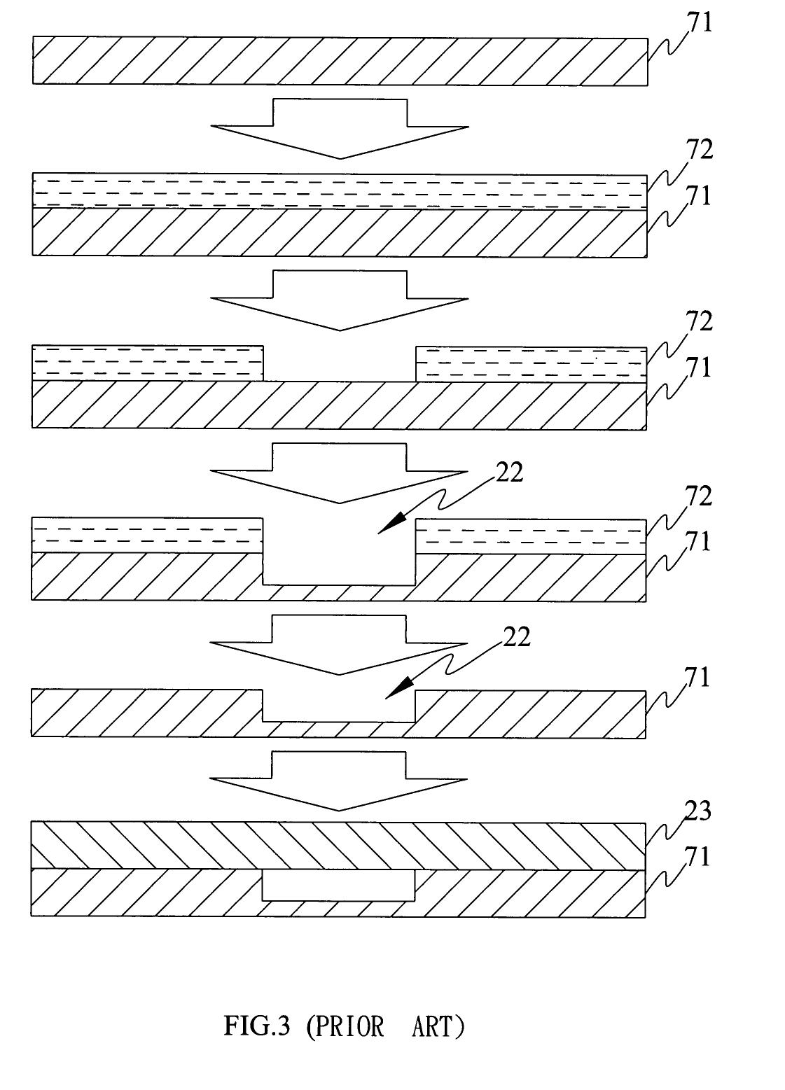

FIG. 4 illustrates a schematic view of a micro-fluidic detector in accordance with the present invention.

FIG. 5 illustrates a schematic view of another micro-fluidic detector in accordance with the present invention.

FIG. 6 illustrates a schematic view of a micro-fluidic detector having mixing function in accordance with the present invention.

FIG. 7 illustrates a schematic view of another micro-fluidic detector having mixing function in accordance with the present invention.

FIG. 8 illustrates a schematic view of an operating sequence of a mixing area of a micro-fluidic detector in accordance with the present invention.

FIG. 9 illustrates a schematic view of an operating sequence of a flow area of a micro-fluidic detector in accordance with the present invention.

FIG. 10 illustrates a flow diagram of a manufacturing method of a micro-fluidic detector in accordance with the present invention.

FIG. 11 illustrates a schematic view of a manufacturing process of a micro-fluidic detector in accordance with the present invention.

FIG. 12 illustrates a schematic view of another micro-fluidic detector having mixing function in accordance with the present invention.

FIG. 13 illustrates a schematic view of another micro-fluidic detector having mixing function in accordance with the present invention.

FIG. 14 illustrates a schematic view of another micro-fluidic detector in accordance with the present invention.

FIG. 15 illustrates a schematic view of another micro-fluidic detector in accordance with the present invention.

### DETAILED DESCRIPTION OF THE PREFERRED EMBODIMENTS

The present invention relates to a micro-fluidic detector and manufacturing method. While the specifications describe at least one embodiment of the invention considered best modes of practicing the invention, it should be understood that the invention can be implemented in many ways and is not limited to the particular examples described below or to the particular manner in which any features of such examples are implemented.

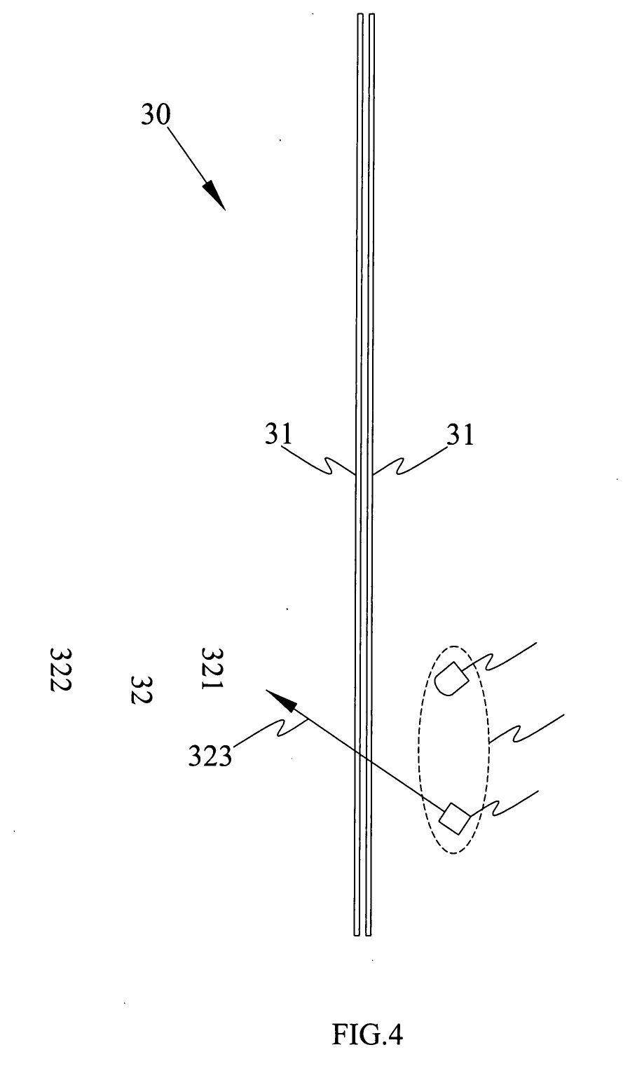

FIG. 4 illustrates a schematic view of a micro-fluidic detector in accordance with the present invention. A micro-fluidic detector 30 for detecting analytes in a fluid sample comprises two electrodes 31 located on the same plane, and a detection module 32. The electrodes 31 are long and narrow strips positioned side by side and serve as a flow area for the fluid sample. The detection module 32 comprises a light emitting device 322 and an analysis unit 321. The light emitting device 322 irradiates an excitation light 323 to excite an analyte in the fluid sample to emit fluorescent light, and an analysis unit 321 is used to receive the fluorescent light for detection of the analyte in fluid sample flowing in the flow area. The electrodes 31 are used for generating electric field to induce the liquid dielectrophoresis for driving the fluid sample to flow.

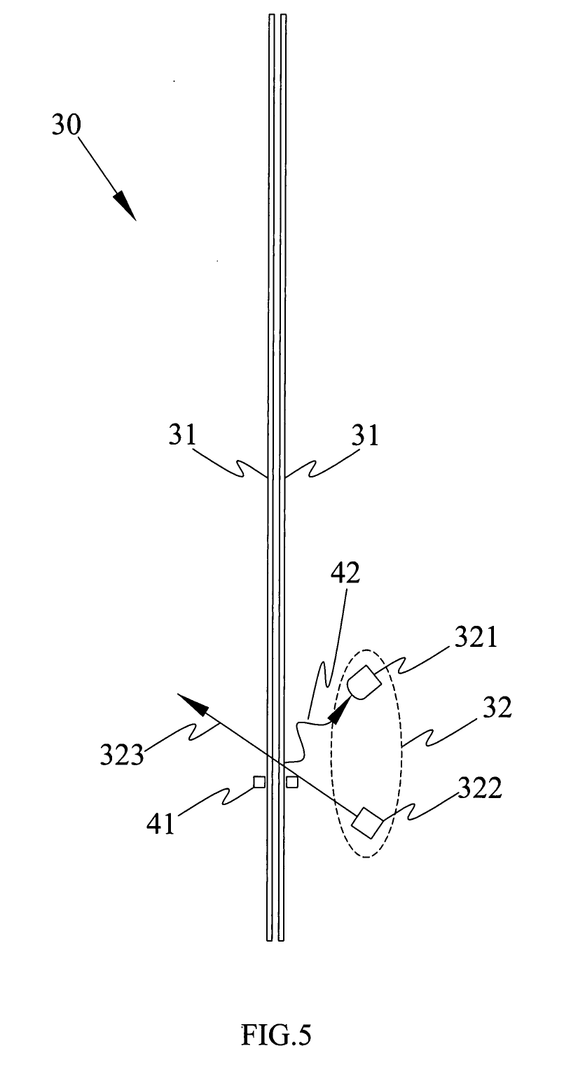

FIG. 5 illustrates a schematic view of other micro-fluidic detector in accordance with the present invention. A micro-fluidic detector 30 is applied for detecting analytes in a fluid sample and comprises two electrodes 31, a detection module 32, and two separators 41. The electrodes 31 are long and narrow strips positioned side by side and serve as a flow area for the fluid sample. The detection module 32 comprises a light emitting device 322 and an analysis unit 321. The light emitting device 322 irradiates an excitation light 323 to excite an analyte in the fluid sample to emit a fluorescent light 42, and analysis unit 321 is used for receiving the fluorescent light 42 for detection of the analyte in the fluid sample flowing in the flow area.

The electrodes 31 are used for generating electric field to induce the liquid dielectrophoresis for driving the fluid sample to flow. The separators 41 are arranged on the same plane and on both sides of the electrodes 31 in the flow area. When the analysis unit 321 detects the fluorescent light 42 emitted from the analyte, the separator 41 then immediately collects the analyte. Therefore the detection and collection of the analyte in the fluid sample can be achieved.

As illustrated in FIGS. 4 and 5, preferably, the electrodes are electrical conductive materials. Preferably, a dielectric layer is coated on the surface of the electrode to prevent the fluid sample from being electrolyzed. Preferably, a hydrophobic thin film is further coated on the dielectric layer to enhance the fluid dielectrophoresis. Preferably, the fluid sample is related to a mixed solution containing at least one analyte which generally is bacteria, virus, cell, protein molecule, drug molecule, DNA molecule, RNA molecule or chemical molecule. Preferably, the analyte is conjugated with a labeled antibody, and the label of the labeled antibody is preferred to be a fluorescent dye, nanoparticle, quantum dot, or any other light emitting dyes. The light emitting device is preferred to be a laser, UV, or IR related device to excite the label to emit fluorescent light. If necessary, the micro-fluidic detector can comprises two or more detection modules.

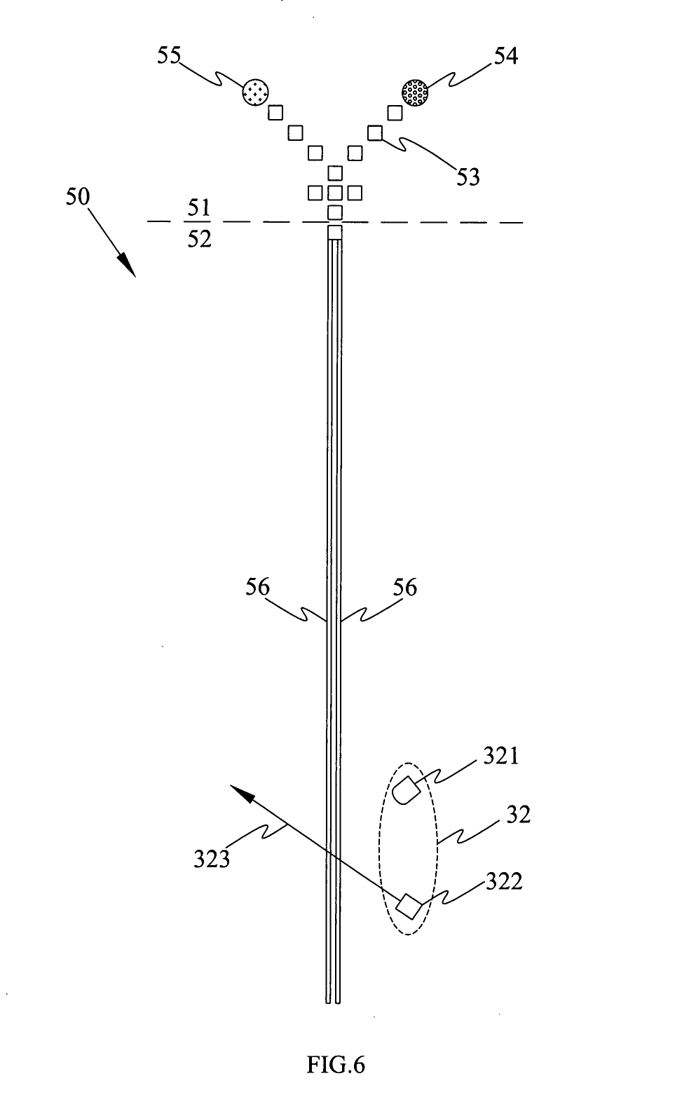

Please referring to FIG. 6 for a schematic view of a micro-fluidic detector having mixing function in accordance with the present invention, a micro-fluidic detector 50 comprises a mixing area 41, a flow area 52, and a detection module 32. The mixing area 51 has a conductive top plate (not illustrated) and multiple first electrodes 53. The conductive top plate covers all the first electrodes 53. A first fluid 54 and a second fluid 55 are mixed between the conductive top plate and the first electrodes 53 to form the fluid sample. The flow area 51 provides a space for the fluid sample to flow and comprises two second electrodes 56 which are long and narrow strips positioned side by side and serve as a flow area for the fluid sample. The detection module 32 comprises a light emitting device 322 and an analysis unit 321. The light emitting device 322 irradiates an excitation light 323 to excite an analyte in the fluid sample to emit fluorescent light. The analysis unit 321 is used to receive the fluorescent light for detection of the analyte in the fluid sample flowing in the flow area.

In the mixing area 51, a voltage potential, with respect to the conductive top plate, is applied to one by one of the first electrodes for generating electric field to induce an electro-wetting phenomenon which is applied for mixing the first fluid 54 and the second fluid 55. In the flow area 52, a liquid dielectrophoresis is induced by the electric field generated by the two second electrodes 56 to drive the fluid sample to flow.

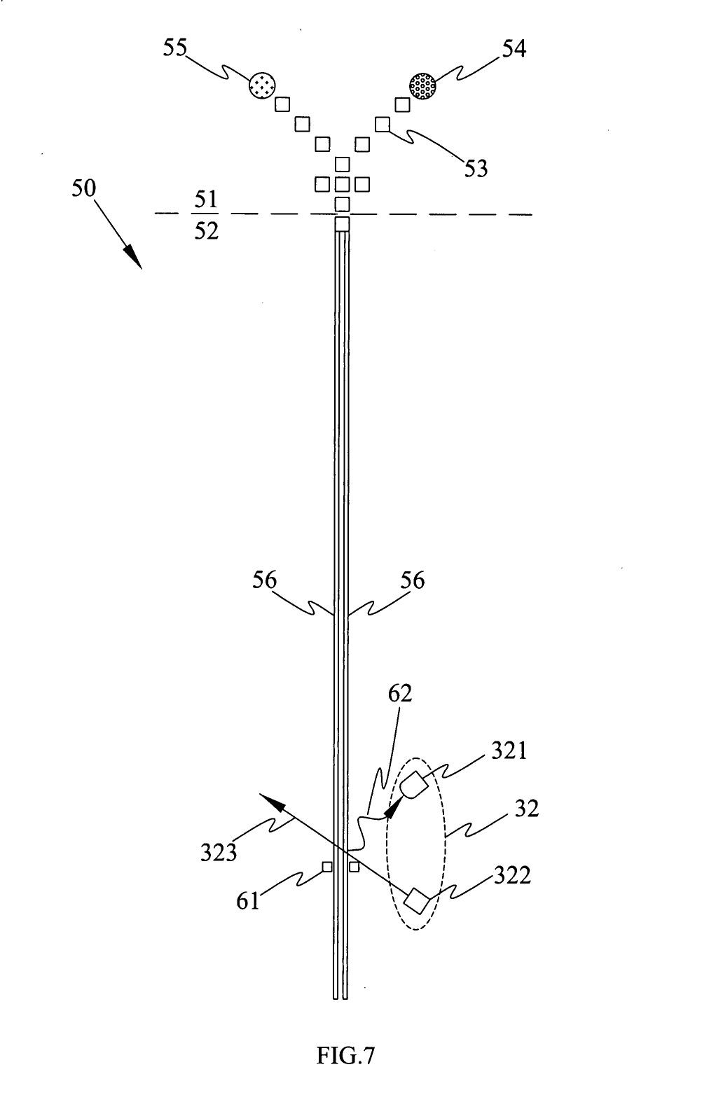

FIG. 7 illustrates a schematic view of another micro-fluidic detector having mixing function in accordance with the present invention. A micro-fluidic detector 50 is applied for detecting analytes in a fluid sample and comprises a mixing area 51, a flow area 52, a detection module 32, and two separators 61. The mixing area 51 has a conductive top plate (not illustrated) and multiple first electrodes 53. The conductive top plate covers all the first electrodes 53. A first fluid 54 and a second fluid 55 are mixed at where between the conductive top plate and the first electrodes 53 to form the fluid sample. The flow area 52 provides a space for the fluid sample to flow and has two second electrodes 56 which are long and narrow strips positioned side by side and serve as a flow area for the fluid sample. The detection module 32 comprises a light emitting device 322 and an analysis unit 321. The light emitting device 322 irradiates an excitation light 323 to excite an analyte in the fluid sample to emit a fluorescent light 62, and analysis unit 321 is used to receive the fluorescent light 62 for detection of the analyte in the fluid sample flowing in the flow area. In the mixing area 51, a voltage potential, with respect to the conductive top plate, is applied to one by one of the first electrodes for generating electric field to induce an electro-wetting phenomenon for the mixing of the first fluid 54 and the second fluid 55. In the flow area 52, a liquid dielectrophoresis is induced by the electric field generated by the two second electrodes 56 to drive the fluid sample to flow. The two separators 61 are respectively disposed on both sides of the flow area 52 and on the same plane. While the analysis unit 321 detects the fluorescent light 62 emitted from the analyte, the separator 61 immediately collects the analyte. Therefore, the detection and collection of the analyte in the fluid sample can be achieved.

As illustrated in FIG. 6 and FIG. 7, the first electrode and the second electrode are each preferred to be made of metallic material or electrical conductive materials. Preferably, a dielectric layer is coated on the surface of the first and the second electrodes to prevent the fluid sample from being electrolyzed. Preferably, the conductive top plate is related to a metallic material or a glass with conductive coating. Preferably, a hydrophobic thin film is further coated on the dielectric layer and the conductive top plate to enhance the electro-wetting phenomenon and the liquid dielectrophoresis. Preferably, the first fluid is related to a mixed solution containing at least one analyte and the second fluid is related to a mixed solution contains at least one labeled antibody. Preferably, the analyte is related to bacteria, virus, cell, protein molecule, drug molecule, DNA molecule, RNA molecule or chemical molecule. The label of the labeled antibody is preferred to be a fluorescent dye, nanoparticle, quantum dot, or any other light emitting dyes. The light emitting device is preferred to be a laser, UV, or IR related device to excite the label to emit fluorescent light.

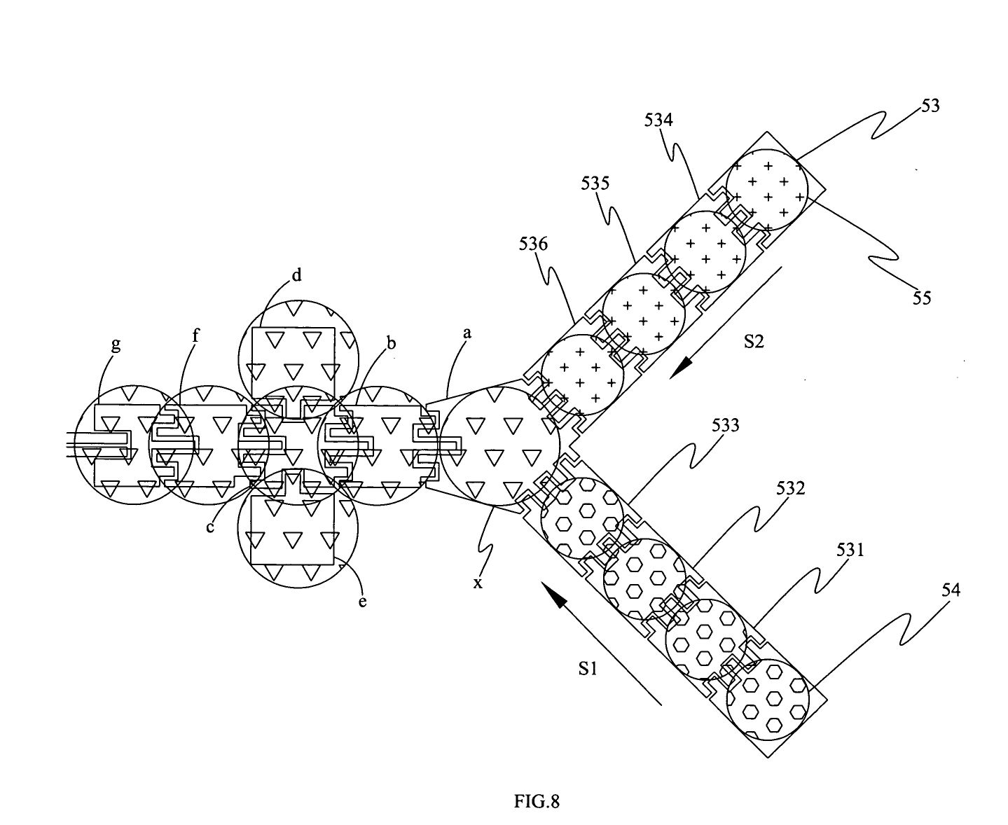

FIG. 8 illustrates an operating sequence of a mixing area of an embodiment of a micro-fluidic detector in accordance with the present invention, and also illustrates the operating sequence of the mixing area 51 respectively of the preferred embodiments illustrated in FIG. 6 and FIG. 7. At first, a voltage across the conductive top plate (not illustrated) and the electrodes 531 and 534 is applied to respectively attract a drop of the first fluid 54 and a drop of the second fluid 55. Upon attracting a drop of the first fluid 54, a voltage potential, with respect to the conductive top plate, is applied to one by one of the electrodes 532, 533 and (a). And one by one of the surfaces of these electrodes become hydrophilic and attract the drop of the first fluid 54 sequentially due to the electrowetting phenomenon. Therefore, the drop of the first fluid 54 moves in a direction designated by SI along the surfaces of electrodes 531, 532, 533 and reaches the electrode (a).

Upon attracting a drop of the second fluid 55, a voltage potential, with respect to the conductive top plate (not illustrated), is applied to one by one of the electrodes 535, 536 and (a). And one by one of the surfaces of these electrodes become hydrophilic and attract the drop of the first fluid 55 sequentially due to the electrowetting phenomenon. Therefore, the drop of the second fluid 55 moves in a direction designated by S2 along the surfaces of electrodes 534, 535, 536 and reaches the electrode (a).

The drop of the first fluid 54 and the drop of the second fluid 55 mixes to form the drop X of the fluid sample at the electrode (a). To assure uniform mixing of the first fluid 54 and the second fluid 55 in the drop X, a voltage potential, with respect to the conductive top plate (not illustrated), is applied to one by one of the electrodes (a), (b), (c), (d), (c), (e), (c), (f), and (g). The surface of each of these electrodes becomes, one by one, hydrophilic and attracts the drop X sequentially due to the electro-wetting phenomenon. Therefore, the drop X moves in a path following the pattern formed by the surface areas of electrodes (a), (b), (c), (d), (c), (e), (c), (f), and (g). After this, a chaotic fluid motion is generated inside the drop X so that the first fluid 54 and the second fluid 55 can be uniformly mixed for reaction. Meanwhile, a serration arrangement can be designed between the electrodes to promote electro-wetting phenomenon.

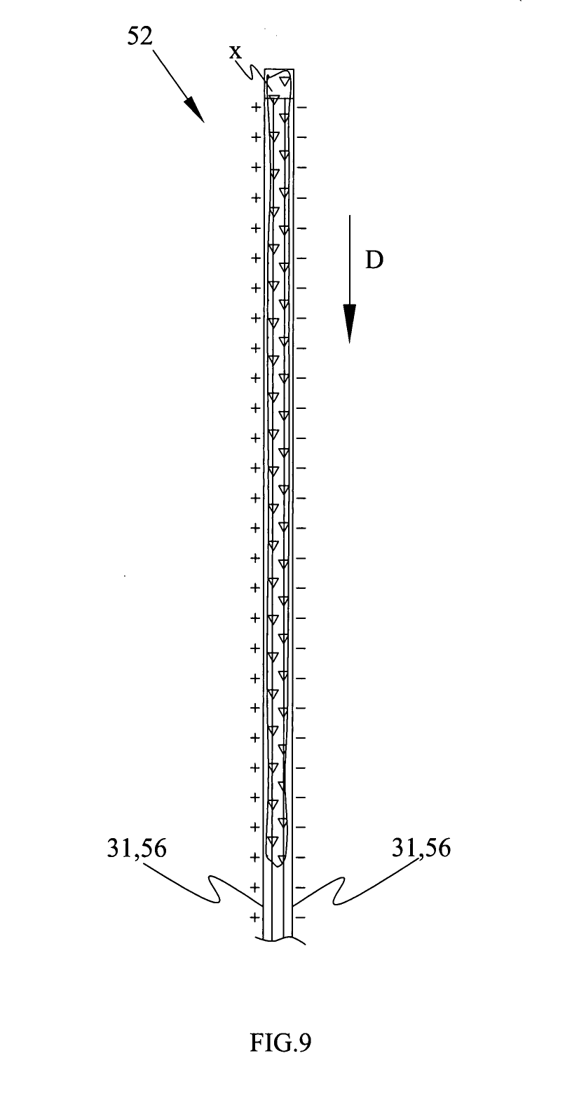

FIG. 9 illustrates an operating sequence of the micro-fluidic detector in accordance with the present invention. Two electrodes are long and narrow strips positioned side by side and serve as a flow area for the fluid sample, as electrodes 31 shown in FIG. 4 and FIG. 5 and as electrodes 56 shown in FIG. 6 and FIG. 7. Two electrodes are applied with an AC field to form a non-uniform electric field (i.e., the electric field in the edge of the electrode is the strongest). Within in this non-uniform electric field, a motive force induced by the dielectrophoresis is exerted on the fluid molecules in the drop X of the fluid sample, and thereby stretches the drop X into a lineal shape and drives the fluid sample to flow in a direction D along the paired electrodes 31 or 56.

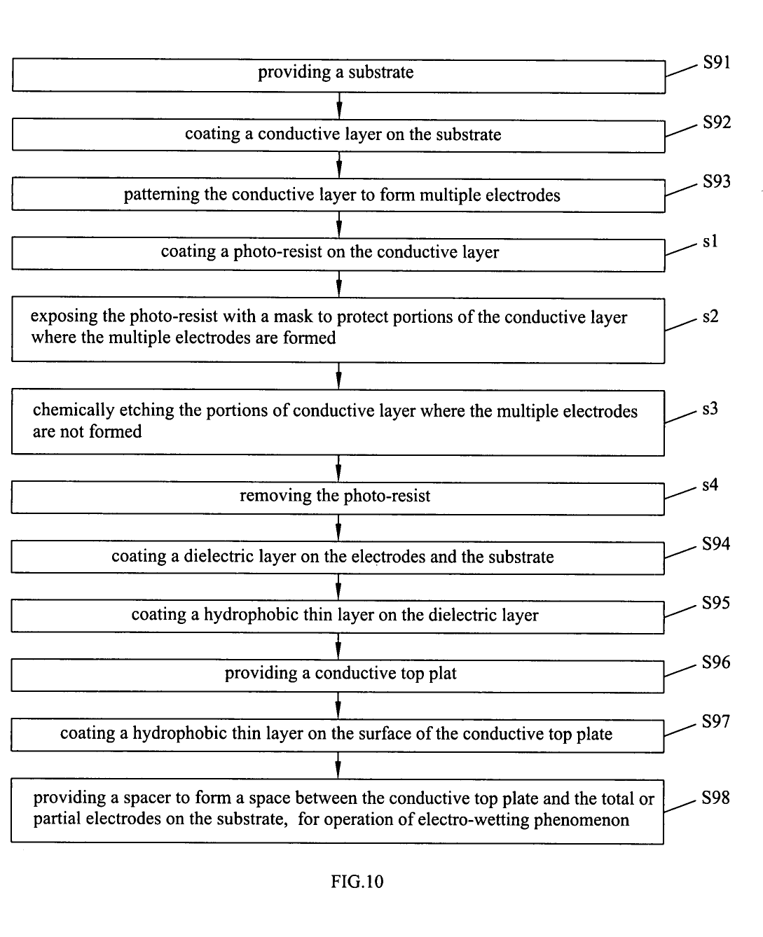

FIG. 10 illustrates a method for manufacturing a micro-fluidic detector in accordance with the present invention. The method includes the following steps of:

S91: providing a substrate;

S92: coating a conductive layer on the substrate;

S93: patterning the conductive layer to form multiple electrodes; and this step further includes the following steps of:

s1: coating a photo-resist on the conductive layer;

s2: exposing the photo-resist with a mask to protect portions of the conductive layer where the multiple electrodes are formed;

s3: chemically etching the portions of conductive layer where the multiple electrodes are not formed; and

s4: removing the photo-resist.

Furthermore, a detection module can be disposed surrounding the electrodes by using the micro electromechanical process technology.

S94: coating a dielectric layer on the electrodes and the substrate;

S95: coating a hydrophobic thin layer on the dielectric layer;

S96: providing a conductive top plate;

S97: coating a hydrophobic thin layer on the surface of the conductive top plate; and

S98: providing a spacer to form a space between the conductive top plate and the total or partial electrodes on the substrate, for operation of electro-wetting phenomenon.

Meanwhile, the electrodes not covered by the conductive top plate are used for operation of the liquid dielectrophoresis. Preferably, metal materials are provided for making electrodes. Preferably, a metal material or a glass with an InSnO surface layer is provided to form the conductive top plate. Preferably, the detection module can comprise a light emitting device and an analysis unit. A separator may be disposed to at least one side of the electrode. Preferably, a hydrophobic thin layer may be coated on a surface of the conductive top plate.

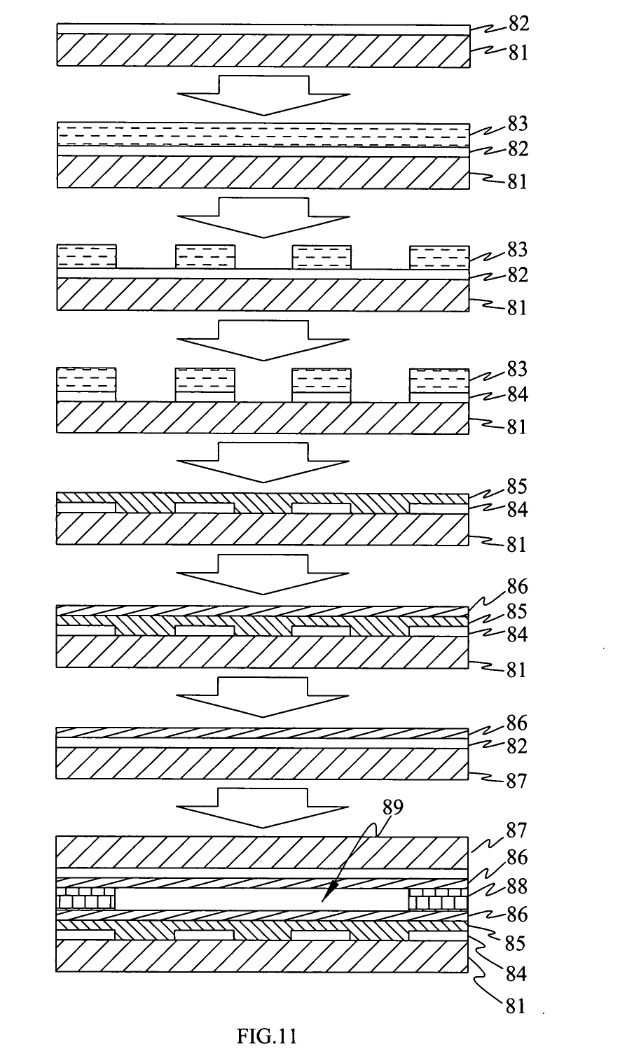

Please referring to FIG. 11 for a schematic view of the manufacturing process of the micro-fluidic detector in accordance with the present invention, a substrate 81 is provided and a conductive layer 82 is formed on the substrate 81 at first. A photo-resist 83 is then coated on the conductive layer 82 and is exposed and developed to protect the portion of the conductive layer 82 where the multiple electrodes are formed. The portion of the conductive layer 82 not protected is removed by a chemical etching process to form multiple electrodes 84. The photo-resist 83 on the electrodes 84 is then removed. Both of the electrode 84 and the substrate 81 are covered with a dielectric layer 85. Followingly, a hydrophobic thin layer is coated on the dielectric layer 85, and a conductive top plate with the conductive layer 82 is provided. A hydrophobic thin layer 86 is coated on the conductive layer of the conductive top plate 87. A spacer 88 is then disposed to form a space 89 between the conductive top plate 87 and total or partial of the electrodes 84 on the substrate 81 for operation of dielectro-phoresis or electro-wetting phenomenon.

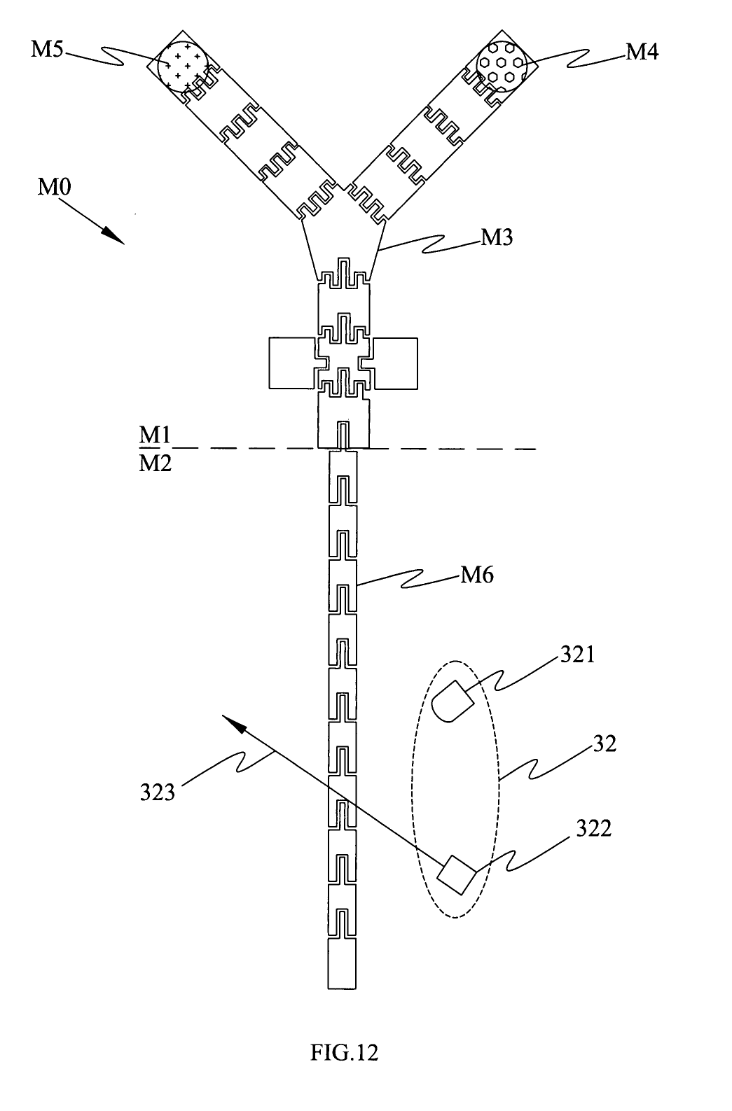

FIG. 12 illustrates a schematic view of another micro-fluidic detector in accordance with the present invention. A micro-fluidic detector M0 applied for detecting analytes in a fluid sample comprises a mixing area M1, a flow area M2, and a detection module 32. The mixing area M1 has a conductive top plate (not illustrated) and multiple first electrodes M3. The conductive top plate covers all the first electrodes M3. A first fluid M4 and a second fluid M5 are mixed at where between the conductive top plate and the first electrodes M3 to form the fluid sample. The flow area M2 has a conductive top plate (not illustrated) and multiple second electrodes M6 arranged in series, and the area of the second electrodes M6 is smaller than the area of the first electrodes M3. The detection module 32 comprises a light emitting device 322 and an analysis unit 321. An excitation light 323 irradiated from the light emitting device 322 excites an analyte in the fluid sample to emit fluorescent light, and the analysis unit 321 is used to receive the fluorescent light for detection of the analyte in the fluid sample flowing in the flow area.

In the mixing area M1, a voltage potential, with respect to the conductive top plate (not illustrated), is applied to one by one of the first electrodes M3 to induce an electro-wetting phenomenon for mixing the first fluid M4 and the second fluid M5. In the flow area M2, a voltage potential, with respect to the conductive top plate (not illustrated), is applied to one by one of the second electrodes M6 to induce an electro-wetting phenomenon for driving the fluid sample to move in a form of a drop; or alternatively, a voltage potential, with respect to the conductive top plate (not illustrated), is applied to, one by one, each set of multiple neighboring second electrodes M6 to induce the electro-wetting phenomenon for driving the fluid sample in a form of a strip.

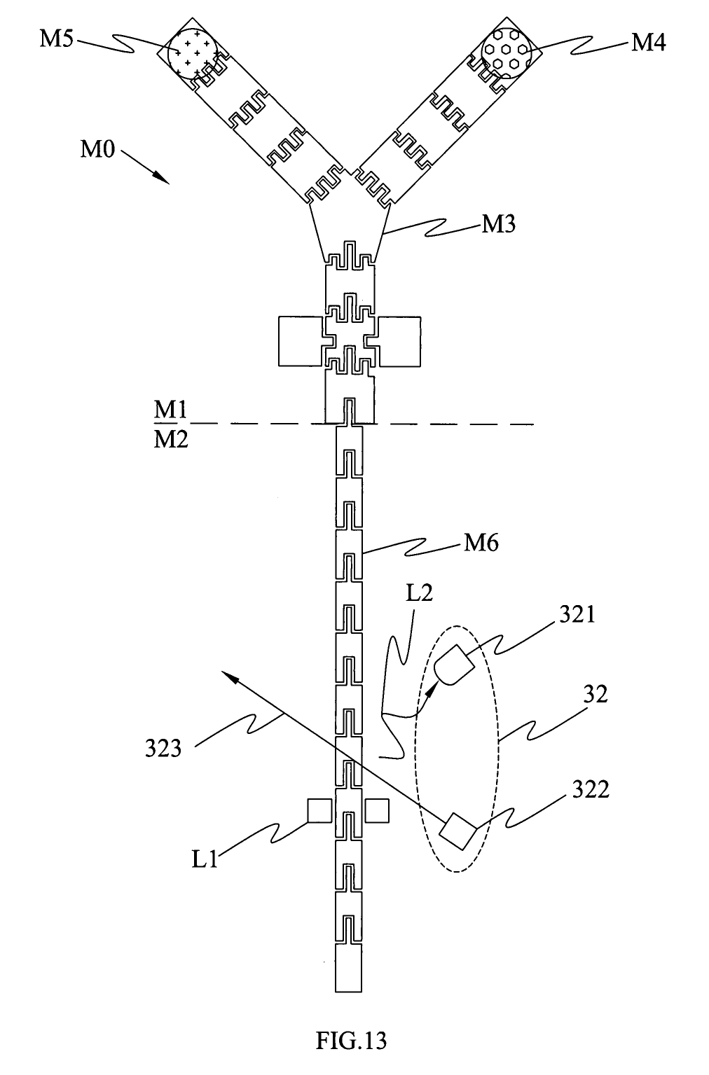

FIG. 13 illustrates a schematic view of another micro-fluidic detector in accordance with the present invention. A micro-fluidic detector M0 for detecting analytes in a fluid sample comprises a mixing area M1, a flow area M2, a detection module 32, and multiple separators L1. The mixing area M1 has a conductive top plate (not illustrated) and multiple first electrodes M3, and the conductive top plate covers all the first electrodes M3. A first fluid M4 and a second fluid M5 are mixed at where between the conductive top plate and the first electrodes M3 to form the fluid sample. The flow area M2 contains a conductive top plate (not illustrated) and multiple second electrodes M6 arranged in series. The area of the second electrodes M6 is smaller than the area of the first electrodes M3. The detection module 32 comprises a light emitting device 322 and an analysis unit 321. The light emitting device 322 irradiates an excitation light 323 to excite an analyte in the fluid sample to emit a fluorescent light L2, and the analysis unit 321 is used for receiving the fluorescent light L2 for detection of the analyte in the fluid sample flowing in the flow area.

In the mixing area M1, a voltage potential, with respect to the conductive top plate (not illustrated), is applied to one by one of the first electrodes M3 to induce an electro-wetting phenomenon for mixing the first fluid M4 and the second fluid M5. In the flow area M2, a voltage potential, with respect to the conductive top plate (not illustrated), is applied to one by one of the second electrodes M6 to induce an electro-wetting phenomenon for driving the fluid sample to move in a form of a drop; or alternatively, a voltage potential, with respect to the conductive top plate (not illustrated), is applied to, one by one, each set of multiple neighboring second electrodes M6 to induce the electro-wetting phenomenon for driving the fluid sample in a form of a strip.

Meanwhile, the separators L1 are arranged on both sides of the flow area M2 and on the same plane. When the analysis unit 321 detects the fluorescent light L2 emitted from the analyte, separators L1 immediately collect the analyte to achieve the purposes of detection and collection of the analyte in the fluid sample.

Preferably, the first electrode and the second electrode illustrated in FIG. 12 and FIG. 13 can be made of metallic material, and a dielectric layer is coated on the surface of the first and the second electrodes to prevent the fluid sample from being electrolyzed. The conductive top plate could be a metallic material or a glass coated with a conductive surface layer. A hydrophobic thin film is further coated on the dielectric layer and the conductive top plate to enhance the electro-wetting phenomenon and the fluid dielectrophoresis. The first fluid is usually related to a mixed solution containing one or a plurality of analyte and the second fluid generally is related to a mixed solution contains one or a plurality of labeled antibody. The analyte generally is related to bacteria, virus, cell, protein molecule, drug molecule, DNA molecule, RNA molecule or chemical molecule. The label of the labeled antibody is preferred to be a fluorescent dye, nanoparticle, quantum dot, or any other light emitting dyes. The light emitting device is preferred to be a laser, UV, or IR related device to excite the label to emit fluorescent light.

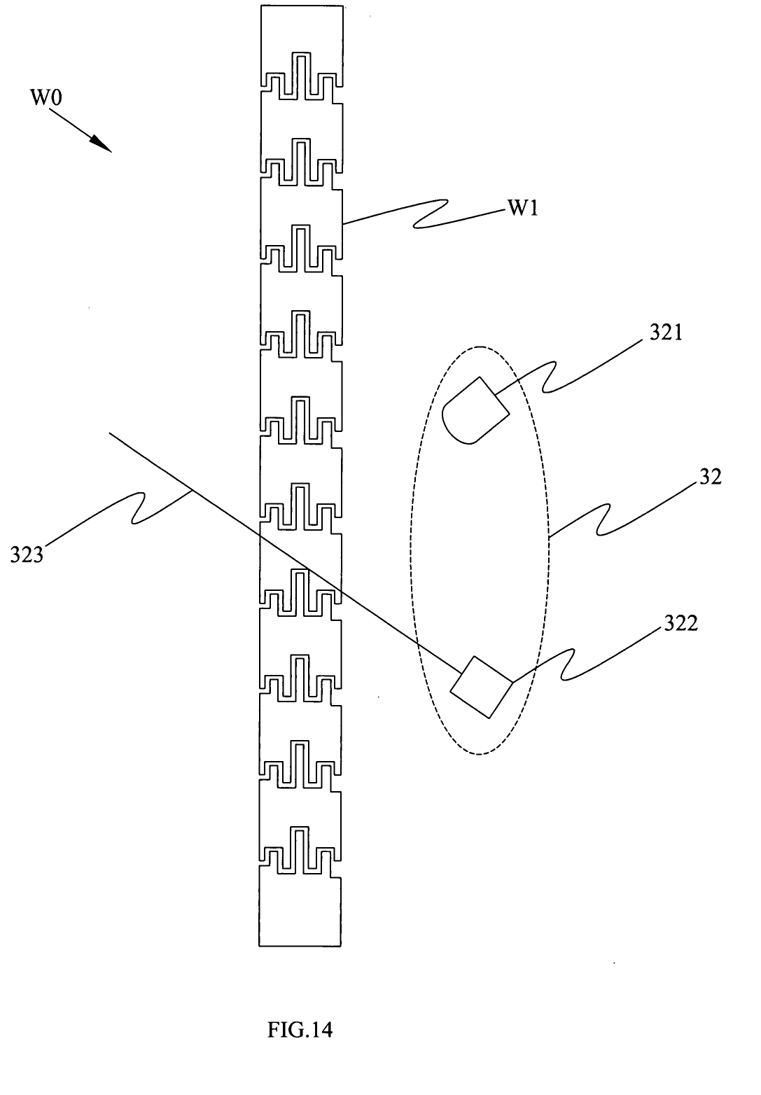

FIG. 14 illustrates a schematic view of another micro-fluidic detector in accordance with the present invention. A micro-fluidic detector W0 for detecting analytes in a fluid sample comprises multiple electrodes W1, a conductive top plate (not illustrated), and a detection module 32. The electrodes W1 are located on the same plane and arranged in series to serve as a flow area for the fluid sample. The detection module 32 comprises a light emitting device 322 and an analysis unit 321. An excitation light 323 irradiated from the light emitting device 322 excites an analyte in the fluid sample to emit fluorescent light, and the analysis unit 321 is used to receive the fluorescent light for detection of the analyte in the fluid sample flowing in the flow area.

A voltage potential, with respect to the conductive top plate (not illustrated), is applied to one by one of the electrodes W1 to induce the electro-wetting phenomenon for driving the fluid sample to move in a form of a drop; or alternatively, a voltage potential, with respect to the conductive top plate (not illustrated), is applied to, one by one, each set of multiple neighboring second electrodes W1 to induce the electro-wetting phenomenon for driving the fluid sample to move in a form of a strip.

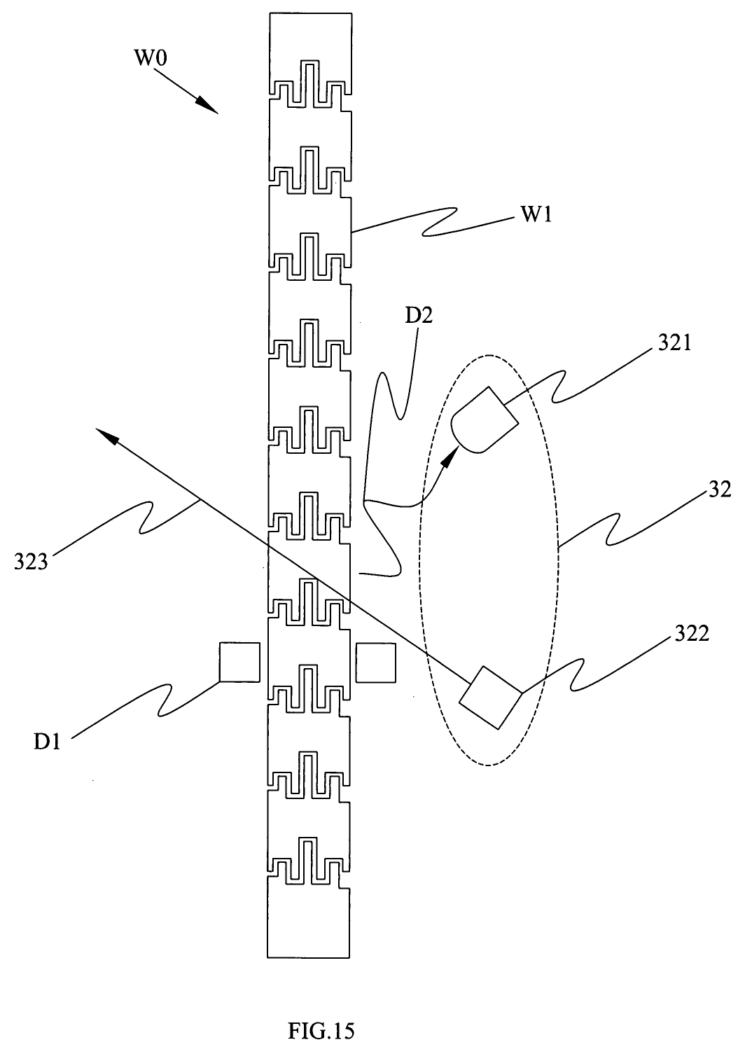

FIG. 15 illustrates a schematic view of another micro-fluidic detector in accordance with the present invention. A micro-fluidic detector W0 for detecting analytes in a fluid sample comprises multiple electrodes W1, a conductive top plate (not illustrated), a detection module 32 and two separators D1. The electrodes W1 are located on a same plane and arranged in series to function as a flow area for the fluid sample. The detection module 32 comprises a light emitting device 322 and an analysis unit 321. An excitation light 323 irradiated from the light emitting device 322 excites an analyte in the fluid sample to emit a fluorescent light D2, and analysis unit 321 is used to receive fluorescent light D2 for detection of the analyte in the fluid sample flowing in the flow area.

A voltage potential, with respect to the conductive top plate (not illustrated), is applied to one by one of the electrodes W1 to induce the electro-wetting phenomenon for driving the fluid sample to move in a form of a drop; or alternatively, a voltage potential, with respect to the conductive top plate (not illustrated), is applied to, one by one, each set of multiple neighboring electrodes W1 to induce the electro-wetting phenomenon for driving the fluid sample to move in a form of a strip. Two separators D1 are respectively disposed on both sides of the electrodes W1 in the flow area and on the same plane. Once the analysis unit 321 detects the fluorescent light D2 emitted from the analyte which is then collected by separators D1 immediately to achieve the purposes of detection and collection of the analyte in the fluid sample.

Preferably, the electrodes as illustrated in FIGS. 14 and 15 are related to metallic materials, and a dielectric layer is coated on a surface of the first and the second electrodes to prevent the fluid sample from being electrolyzed. Preferably, a hydrophobic thin film is further coated on the dielectric layer to help promote an electro-wetting phenomenon and liquid dielectrophoresis. The first fluid is usually related to a mixed solution containing one or a plurality of analyte and the second fluid generally is related to a mixed solution contains at least one labeled antibody. The analyte generally is related to bacteria, virus, cell, protein molecule, drug molecule, DNA molecule, RNA molecule or chemical molecule. The label of the labeled antibody is preferred to be a fluorescent dye, nanoparticle, quantum dot, or any other light emitting dyes. The light emitting device is preferred to be a laser, UV, or IR related device to excite the label to emit fluorescent light.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A micro-fluidic detector for detecting analytes in a fluid sample, comprising:
multiple electrodes, arranged on a same plane, two of the electrodes being long and narrow strips positioned side by side to serve as a flow area for the fluid sample; and
at least one detection module, for detecting analytes in the fluid sample flowing in the flow area;
wherein the fluid sample is driven to flow via an electric field generated by the electrodes.

2. The micro-fluidic detector of claim 1, wherein the electrodes are made of metallic materials.

3. The micro-fluidic detector of claim 1, further comprising a dielectric layer coated on the surfaces of the electrodes.

4. The micro-fluidic detector of claim 3, further comprising a hydrophobic thin film coated on the dielectric layer.

5. The micro-fluidic detector of claim 1, wherein the detection module comprises a light emitting device and an analysis unit.

6. The micro-fluidic detector of claim 1, wherein the fluid sample is related to a mixed solution containing one analyte or a plurality of analytes.

7. The micro-fluidic detector of claim 6, further comprising at least one separator disposed in the flow area to collect the analytes in the fluid sample.

8. The micro-fluidic detector of claim 6, wherein the analyte is related to bacteria, virus, cell, protein molecule, drug molecule, DNA molecule, or RNA molecule.

9. The micro-fluidic detector of claim 6, wherein the analyte is related to an analyte conjugated with a labeled antibody.

10. The micro-fluidic detector of claim 9, wherein the label of the labeled antibody is related to fluorescent dye, nanoparticle, quantum dot or other light emitting dye.

11. A micro-fluidic detector for detecting analytes in a fluid sample, comprising:
a mixing area, having a conductive top plate and multiple first electrodes, and a first fluid and a second fluid being mixed at where between the conductive top plate and the first electrodes to form the fluid sample;
a flow area, having at least two second electrodes being long and narrow strips positioned side by side to serve as a flow area for the fluid sample; and
at least one detection module, for detecting analytes in the fluid sample flowing in the flow area;
wherein a voltage potential, with respect to the conductive up-plate, is applied to one by one of the first electrodes to generate electric field in the mixing area to mix the first and the second fluids, and the fluid sample being driven to flow in the flow area via electric field generated by the second electrodes.

12. The micro-fluidic detector of claim 11, wherein the first or second electrodes are related to metallic materials.

13. The micro-fluidic detector of claim 11, wherein the conductive top plate is related to a metallic material or a glass with conductive coating.

14. The micro-fluidic detector of claim 11, further comprising a dielectric layer coated on the surfaces of the first and second electrodes.

15. The micro-fluidic detector of claim 14, further comprising a hydrophobic thin film coated on the dielectric layer.

16. The micro-fluidic detector of claim 11, further comprising a hydrophobic thin film coated on the surface of the conductive top plate.

17. The micro-fluidic detector of claim 11, wherein the detection module comprises a light emitting device and an analysis unit.

18. The micro-fluidic detector of claim 11, wherein the first fluid is related to a mixed solution containing one analyte or a plurality of analytes.

19. The micro-fluidic detector of claim 18, further comprising a separator disposed on at least one side of the flow area to collect the analyte in the fluid sample.

20. The micro-fluidic detector of claim 18, wherein the analyte is related to bacterial, virus, cell, protein molecule, drug molecule, DNA molecule, or RNA molecule.

21. The micro-fluidic detector of claim 11, wherein the second fluid is related to a mixed solution containing at least one labeled antibody.

22. The micro-fluidic detector of claim 21, wherein the label of the labeled antibody is related to fluorescent dye, nanoparticle, quantum dot, or other light emitting dye.

23. A micro-fluidic detector for detecting analytes in a fluid sample, comprising:
a mixing area, having a conductive top plate and multiple first electrodes, and a first fluid and a second fluid being mixed at where between the conductive top plate and the first electrodes to form the fluid sample;
a flow area, having a conductive top plate and multiple second electrodes which are arranged in series to drive the fluid sample to flow; and
at least one detection module, for detecting analytes in the fluid sample flowing in the flow area;
a voltage potential, with respect to the conductive top plate, is applied to one by one of the first electrodes to generate electric field in the mixing area to mix the first and the second fluids, and a voltage potential, with respect to the conductive top plate, is applied to one by one of the second electrodes to generate electric field for driving the fluid sample to flow in the flow area.

24. The micro-fluidic detector of claim 23, wherein the first or second electrodes are related to metallic materials.

25. The micro-fluidic detector of claim 23, wherein the conductive top plate is related to a metallic material or a glass with a conductive coating.

26. The micro-fluidic detector of claim 23, further comprising a dielectric layer coated on the surfaces of the first and the second electrodes.

27. The micro-fluidic detector of claim 26, further comprising a hydrophobic thin film coated on the dielectric layer.

28. The micro-fluidic detector of claim 23, further comprising a hydrophobic thin film coated on the surface of the conductive top plate.

29. The micro-fluidic detector of claim 23, wherein the detection module comprises a light emitting device and an analysis unit.

30. The micro-fluidic detector of claim 23, wherein the first fluid is related to a mixed solution containing one analyte or a plurality of analytes.

31. The micro-fluidic detector of claim 30, further comprising a separator disposed on at least one side of the flow area to collect the analyte in the fluid sample.

32. The micro-fluidic detector of claim 30, wherein the analyte is related to bacterial, virus, cell, protein molecule, drug molecule, DNA molecule, or RNA molecule.

33. The micro-fluidic detector of claim 23, wherein the second fluid is related to a mixed solution containing one or a plurality of labeled antibody.

34. The micro-fluidic detector of claim 33, wherein the label of the labeled antibody is related to fluorescent dye, nanoparticle, quantum dot, or other light emitting dye.

35. A micro-fluidic detector manufacturing method comprising the steps of:
providing a substrate;
forming a conduct layer on the substrate;
patterning the conduct layer to form multiple electrodes; and
installing at least one detection module surrounding the electrodes.

36. The micro-fluidic detector manufacturing process of claim 35, further comprising step of providing a conductive top plate being above certain portion of the electrodes, wherein a spacer is provided to create a space between the conductive top plate and the electrodes on the substrate.

37. The micro-fluidic detector manufacturing process of claim 35, further comprising a step of providing a conductive top plate being above all the electrodes, wherein a spacer is provided to create a space between the conductive top plate and the electrodes on the substrate.

38. The micro-fluidic detector manufacturing process of claim 35, wherein the step of patterning the conductive layer further comprises a step of coating a photo-resist on the conductive layer, wherein the photo-resist is exposed to protect the conductive layer where multiple electrodes are formed, and the conductive layer where not protected is processed with chemical etching to form the electrodes, and the photo-resist over the electrodes is then removed.

39. The micro-fluidic detector manufacturing process of claim 35, further comprising a step of covering the electrodes and the substrate with a dielectric layer.

40. The micro-fluidic detector manufacturing process of claim 36 or 37, wherein the process further includes the preparation of a metallic material or a glass with a conductive coating to function as the conductive top plate.

41. The micro-fluidic detector manufacturing process of claim 36 or 37, wherein the process further includes coating a hydrophobic thin layer on the surface of the conductive top plate.

42. The micro-fluidic detector manufacturing process of claim 35, wherein the process further includes preparation of a metallic material to function as the conductive layer.

43. The micro-fluidic detector manufacturing process of claim 35, further comprising a step of coating a hydrophobic thin layer on the dielectric layer.

44. The micro-fluidic detector manufacturing process of claim 35, wherein the detection module comprises a light emitting device and an analysis unit.

45. The micro-fluidic detector manufacturing process of claim 35, further comprising a step of installing a separator disposed on at least one side of the electrodes.

46. A micro-fluidic detector for detecting analytes in a fluid sample, comprising:
multiple electrodes, disposed on a same plane and arranged in series to serve as a flow area for the fluid sample; and
at least one detection module, for detecting analytes in the fluid sample flowing in the flow area;
wherein the fluid sample is driven to flow in the flow area by an electric field generated by the electrodes.

47. The micro-fluidic detector of claim 46, wherein the electrodes are made of metallic material.

48. The micro-fluidic detector of claim 46, further comprising a dielectric layer covering the surfaces of the electrodes.

49. The micro-fluidic detector of claim 46, further comprising a hydrophobic thin layer coated on the dielectric layer.

50. The micro-fluidic detector of claim 46, wherein the detection module comprises a light emitting device and an analysis unit.

51. The micro-fluidic detector of claim 46, wherein the fluid sample is related to a mixed solution containing one analyte or a plurality of analytes.

52. The micro-fluidic detector of claim 51, further comprising a separator disposed on at least one side of the flow area to collect analyte from the fluid sample.

53. The micro-fluidic detector of claim 51, wherein the analyte is related to bacterial, virus, cell, protein molecule, drug molecule, DNA molecule, or RNA molecule.

54. The micro-fluidic detector of claim 51, wherein the analyte is related to one that is combined with a labeled antibody.

55. The micro-fluidic detector of claim 54, wherein the label of the labeled antibody is related to fluorescent dye, nanoparticle, quantum dot, or other light emitting dye.
